(19) United States
(12) Patent Application Publication
(10) Pub. No.: US 2007/0102238 A1
(43) Pub. Date: May 10, 2007

(54) Acoustical panel using wood veneer

(76) Inventor: Reginald W. Low, Winnipeg (CA)

Correspondence Address: ADE & COMPANY INC., 2157 Henderson Highway, WINNIPEG, MB, R2G1P9, CA

(21) Appl. No.: 11/269,888

(22) Filed: Nov. 9, 2005

(51) Int. Cl. E04B 1/82; G10K 11/16

(52) U.S. Cl. 181/290; 181/296

(57) ABSTRACT

An acoustical panel is formed from a core of glass fiber reinforced material which is acoustically porous so as to absorb sound waves with the core being sufficiently rigid to form the panel for supporting within an area where sound waves are to be absorbed. On the front surface is adhesively attached a sheet of wood veneer to provide an attractive front surface for presentation into the area such that the sound waves in the area impact upon the sheet. The sheet is perforated prior to adhesive attachment over its entire surface with an array of punched holes of a number and size sufficient to allow passage through the sheet of sound waves for transfer into the core so that the punched holes extend through the sheet only.

The invention relates to an improved acoustical panel.

### BACKGROUND OF THE INVENTION

Acoustical panels are well known for mounting on walls in vertical orientation, horizontally as ceiling panels or in some cases as individually suspended elements known as “clouds”.

Many different types of acoustical panels are known and the intention is that the acoustical panels act to absorb sound waves from an area, primarily in a room, within which the panels are mounted.

The panel must therefore be porous so that the sound waves can enter. In some cases the panel includes a rear reflective sheet, but this is not essential, as is well known to one skilled in the art.

In many cases the panel is attached into a frame or suspension system. Thus edges of the panels may be shaped and arranged so that the panels cooperate with known or existing suspension hardware such as suspended ceilings. The panels must have sufficient stiffness that they can be self supporting when mounted in the necessary support structure.

In some cases the panel is attached by hardware which is engaged into the panel itself and provides a rigid support or attachment for engaging with hanging elements attached to a wall or ceiling.

The present invention is primarily concerned with panels of the type formed from a core of a glass fiber reinforced material which has a density such that it is porous to the sound waves. Such boards or panels are slightly compressible and have a relatively smooth surface at the front and rear with side edges which are generally at right angles to the front and rear surfaces.

Such glass fiber reinforced cores are generally of the order of 1″ in thickness but can in some cases be up to 2″ in thickness.

The cores are covered by a suitable covering material which provides an attractive surface. In some cases this covering is merely a specialized paint which simply acts to color the panel to a required decorative finish and to provide a more effective texture to the panel. Such paints are selected so that they are transparent to sound waves or at least allow sufficient sound waves to pass through so that the sound waves may enter into the glass fiber reinforced material for absorption.

Other covering materials have been used including fabrics and vinyl sheets which can be selected to a required color and texture. However such covering materials are required to be flexible to a degree sufficient to bend through an angle of the order of 90° so that the fabrics can be wrapped around the edges of the panel to attach to the edges and back. Suitable adhesives are available to provide effective attachment of the fabric or vinyl sheet to the front surface of the fiber glass core.

### SUMMARY OF THE INVENTION

It is one object of the invention to provide an improved acoustical panel.

According to one aspect of the invention there is provided an acoustical panel comprising:

a core of glass fiber reinforced material which is acoustically porous so as to absorb sound waves;

the core having a front surface, a rear surface spaced from the front surface by a thickness of the core, and side edges,

the core being sufficiently rigid to form the panel for supporting within an area where sound waves are to be absorbed;

a sheet of wood veneer;

the sheet being bonded by an adhesive to the front surface of the core so as to substantially cover the front surface of the core and to provide an attractive front surface for presentation into the area such that the sound waves in the area impact upon the sheet;

the sheet being perforated over its entire surface with an array of punched holes of a number and size sufficient to allow passage through the sheet of sound waves for transfer into the core;

the punched holes extending through the sheet only.

Preferably the sheet has at least one side portion, preferably two and in most cases four side portions which are bent so as to lie against a respective side edge of the core and is adhesively bonded to said respective side edge.

Preferably wherein said respective side edge is at right angles to the front surface so that the side portion is bent at 90 degrees.

Preferably the sheet is prevented from cracking during bending by the presence of the holes and the presence of the adhesive.

Preferably the front face of the sheet is coated with a fire retardant sealant coating.

Preferably the coating is clear.

Preferably the sheet of veneer has a thickness less than ⅛ inch.

Preferably the holes punched in the sheet of veneer have a diameter in the range 1/32 to 1/16 inches.

Preferably the holes punched in the sheet of veneer provide a whole area to total area ratio in the range 18 to 22%.

### BRIEF DESCRIPTION OF THE DRAWINGS

One embodiment of the invention will now be described in conjunction with the accompanying drawings in which:

FIG. 1 is a cross-section through an acoustical panel according to the present invention.

FIG. 2 is a schematic side elevational view of a method of perforating the veneer of FIG. 1.

In the drawings like characters of reference indicate corresponding parts in the different figures.

### DETAILED DESCRIPTION

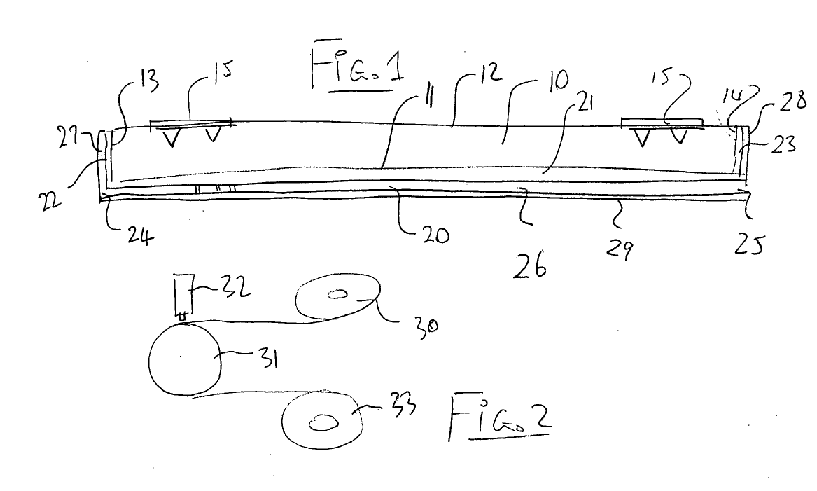

In FIG. 1 is shown an acoustical panel according to the present invention. The acoustical panel includes a core 10 of a glass fiber reinforced material. Such materials are well known to a person skilled in the art and are widely used for such acoustical panels to provide a front surface 11 and a rear surface 12. The panels include side edges 13 and 14 in one direction together with further side edges which are not visible in the other direction. The panels are commonly 1″ to 2″ thick but the thickness can vary in accordance with requirements known to one skilled in the art.

Suitable fasteners 15 can be attached into the rear surface of the panel or core of glass fiber material for hanging the panel in a suitable location. In some cases a rectangular frame is applied around the outside edge of the rear surface to provide additional stiffening. In some cases a rear reflective covering of a foil or the like is attached over the rear surface. All of these elements are of course well known to one skilled in the art and therefore are not shown nor described in detail herein.

The front surface 11 of the core 10 together with the side edges 13 and 14 together with the further two side edges not visible in FIG. 1 are all covered by a wood veneer 20 of the present invention. The wood veneer is attached to the core 10 by a layer 21 of adhesive applied to the front surface 11. Similar layers 22 and 23 of adhesive are located between the wood veneer and the side edges 13 and 14 respectively. Thus the wood veneer is bent at right angles at a junction 24 and 25 so that it lies flat against the front surface 11 and lies flat against the side edges 13, 14 which are at right angles to the surface 11. This requires a formation of a sharp corner 24, 25 in the wood veneer so that it is properly attached and provides a smooth attractive appearance at the edges of the panel. As previously described, in some cases the side edges of the panels are visible and in some cases the side edges are not visible. In most cases it is desirable to bend or crease the wood veneer so as to contact and cover the side edges but in other cases this is not essential and the side edges are left bare.

The veneer is perforated with an array of holes across its full extent. The perforation is carried out as a separate step prior to the shaping and attachment of the veneer to the core 10 and this is carried out in a conventional punching system schematically indicated in FIG. 2. In this figure there is shown a supply 30 of a roll of the veneer which passes over a punch roller 31 which co-operates with a punch press 32 which is reciprocated onto the roller so as to punch out the array of holes within the veneer. The veneer is thus rolled around the roller 31 so as to maintain it tightly in contact with the surface of the roller. The roller is perforated with holes so that the punch 32 providing an array of punch fingers can pass through the veneer to punch out a portion of the veneer. Such punch presses are commercially available and known to person skilled in this art. While it was not expected that veneer could be punched in this way, it is found by experimentation that veneer can be suitably punched to provide a whole array of the type described hereinafter. The veneer will tolerate the bending necessary to transfer it from the supply 30 around the punch roller 31 to a wind up reel 33. The punched holes can be formed without damaging the veneer and with removing the portion punched so that a clean hole is provided. These results were not expected but were achieved surprisingly.

The punched veneer is then cut to shape so as to provide a face portion 26 which overlies the face 11 of the fibre glass panel 10. The side portions indicated at 27 and 28 which are bent at right angles so as to match the side edges. can be formed by a clean bending action, bending the veneer around a straight edge.

This bending action is again unexpected but is achieved by a combination of the presence of the perforations and the application of the adhesive which acts to soften the fibres of the veneer allowing it to bend at 90° without cracking of the veneer.

Therefore surprisingly, it has been found that veneer of this type which is perforated can be bent to take the required shape so that the side edges are formed at right angles to apply to the side edges of the fibreglass panel 10.

In the example selected, the sheet of veneer has a thickness less than ⅛ inch, the holes punched in the sheet of veneer have a diameter in the range 1/32 to 1/16 inches and the holes punched in the sheet of veneer provide a hole area to total area ratio in the range 18 to 22%.

In order to complete the panel, a coating of a fire retardant material 29 is applied over the front surface of the veneer. This coating is applied by brush or airless sprayer at a coating thickness which does not interfere with the presence of the perforations and does not provide a blockage to any of the perforations. Thus the perforations remain open. As the perforations are formed through the veneer prior to application thereof, the perforations extend only through the veneer. The adhesive layer 21 is sufficiently thin that the adhesive itself does not interfere with the passage of sound waves through the perforated holes and into the body of the fibre glass panel 10. Suitable adhesives which attach the veneer to the surface but which do not provide a barrier layer when set are known to persons skilled in this art.

As set forth hereinbefore, the panels can be used vertically for walls, horizontally for ceilings or as separate hung panels known as “clouds”. Simple mounting arrangements of the type described hereinbefore can be used and are well known to one skilled in the art.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An acoustical panel comprising:
a core of glass fiber reinforced material which is acoustically porous so as to absorb sound waves;
the core having a front surface, rear surface spaced from the front surface by a thickness of the core, and side edges,
the core being sufficiently rigid to form the panel for supporting within an area where sound waves are to be absorbed;
a sheet of wood veneer;
the sheet being bonded by an adhesive to the front surface of the core so as to substantially cover the front surface of the core and to provide an attractive front surface for presentation into the area such that the sound waves in the area impact upon the sheet;
the sheet being perforated over its entire surface with an array of punched holes of a number and size sufficient to allow passage through the sheet of sound waves for transfer into the core;
the punched holes extending through the sheet only.

2. The acoustical panel according to claim 1 wherein the sheet has at least one side portion which is bent so as to lie against a respective side edge of the core and is adhesively bonded to said respective side edge.

3. The acoustical panel according to claim 1 wherein said respective side edge is at right angles to the front surface so that the side portion is bent at 90 degrees.

4. The acoustical panel according to claim 1 wherein the sheet has at least two opposed side portions each of which is bent so as to lie against a respective side edge of the core and is adhesively bonded to said respective side edge.

5. The acoustical panel according to claim 1 wherein the sheet has four side portions each at a respective edge of a front face of the sheet and each of which is bent so as to lie against a respective side edge of the core and is adhesively bonded to said respective side edge.

6. The acoustical panel according to claim 1 wherein the sheet is prevented from cracking during bending by the presence of the holes and the presence of the adhesive.

7. The acoustical panel according to claim 1 wherein the front face of the sheet is coated with a fire retardant sealant coating.

8. The acoustical panel according to claim 1 wherein the coating is clear.

9. The acoustical panel according to claim 1 wherein the sheet of veneer has a thickness less than ⅛ inch.

10. The acoustical panel according to claim 1 wherein the holes punched in the sheet of veneer have a diameter in the range 1/16 to 1/32 inches.

11. The acoustical panel according to claim 1 wherein the holes punched in the sheet of veneer provide a hole area to total area ratio in the range 18 to 22%.
